(19) United States
(12) Patent Application Publication
(10) Pub. No.: US 2022/0112318 A1
(43) Pub. Date: Apr. 14, 2022

(54) RESIN COMPOSITION AND ARTICLE MADE THEREFROM

(71) Applicant: Elite Electronic Material (KunShan) Co., Ltd., Kunshan City (CN)

(72) Inventors: Zhenfang SHANG, Kunshan City (CN); Jue TAN, Kunshan City (CN); Chenyu SHEN, Kunshan City (CN); Yan ZHANG, Kunshan City (CN)

(21) Appl. No.: 17/103,274

(22) Filed: Nov. 24, 2020

(30) Foreign Application Priority Data
Oct. 10, 2020 (CN) 202011078922.6

(51) Int. Cl. C08F 136/06; C08L 25/10; C08L 53/02

(52) U.S. Cl. CPC C08F 136/06; C08L 25/10; C08L 53/02; C08L 2201/08; C08J 5/24; C08L 2203/20; C08L 2205/02; C08L 2205/03; C08L 2203/16

(57) ABSTRACT

A resin composition includes: (A) a polybutadiene having a content of 1,2-vinyl group of greater than or equal to 85%; and (B) a styrene-butadiene-styrene triblock copolymer of Formula (1) comprising a butadiene block having a content of 1,2-vinyl group of greater than or equal to 80%. Moreover, an article may be made from the resin composition, which comprises a prepreg, a resin film, a laminate or a printed circuit board. The resin composition or the article made therefrom may achieve improvement in one or more properties including Z-axis ratio of thermal expansion, thermal resistance after moisture absorption, dissipation factor, and dissipation factor aging variation under moisture and heat.

### CROSS-REFERENCE TO RELATED APPLICATION

This application claims the priority benefits of China Patent Application No. 202011078922.6, filed on Oct. 10, 2020. The entirety the above-mentioned patent application is hereby incorporated by reference herein and made a part of this specification.

### BACKGROUND

### 1. Field of the Disclosure

The present disclosure relates to a resin composition and more particularly to a resin composition comprising a polybutadiene and a styrene-butadiene-styrene triblock copolymer, which is useful for making an article such as a prepreg, a resin film, a laminate or a printed circuit board.

### 2. Description of Related Art

With the rapid evolution of electronic technology, data processing of electronic products including mobile communication apparatuses, servers and mainframe computers has been continuously developed towards high frequency signal transmission and high speed digitalization; therefore, low-dielectric materials have become the mainstream for the development of laminates with a high transmission rate so as to meet the demands of high speed data processing.

Conventionally, unsaturated polyphenylene ether resins are widely used as base resins for making low dielectric copper-clad laminates, but copper-clad laminates made from a polyphenylene ether resin have a low glass transition temperature, and the polyphenylene ether resin has poor compatibility with other resins, which causes the problems of high coefficient of thermal expansion and poor thermal resistance, thereby failing to meet the demands of new generation high frequency and low dielectric circuit boards.

To overcome the problems above, bismaleimides have been introduced to improve the resin properties to achieve low ratio of thermal expansion and high thermal resistance of the resin system, but this solution will result in deterioration of the dielectric properties.

Accordingly, there is a need to develop a material for copper-clad laminates that overcomes at least one of the aforesaid technical problems.

### SUMMARY

To overcome the problems of prior arts, particularly one or more above-mentioned technical problems facing conventional materials, it is a primary object of the present disclosure to provide a resin composition and an article made therefrom which may overcome at least one of the above-mentioned technical problems.

Specifically, to address the drawbacks of prior arts, the present disclosure provides a resin composition comprising a polybutadiene and a styrene-butadiene-styrene triblock copolymer and an article made therefrom, which have at least one desirable property including low Z-axis ratio of thermal expansion (Z-PTE), excellent thermal resistance after moisture absorption (PCT), low dissipation factor (Df), and low dissipation factor aging variation under moisture and heat (Df aging rate under moisture and heat, abbreviated herein as “Dfa”).

It is a primary object of the present disclosure to provide a resin composition, comprising: (A) a polybutadiene having a content of 1,2-vinyl group of greater than or equal to 85%; and (B) a styrene-butadiene-styrene triblock copolymer of Formula (1) comprising a butadiene block having a content of 1,2-vinyl group of greater than or equal to 80%:

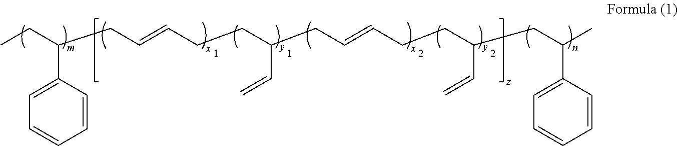

wherein x1, x2, y1 and y2 are each independently an integer of greater than or equal to 0, y1 and y2 are not 0 at the same time, and m, n and z are each independently an integer of greater than or equal to 1, and wherein:
m+n+(x1+x2)*z+(y1+y2)*z=A; m/A=0.1-0.4; n/A=0.1-0.4; [(x1+x2)*z]/A=0-0.1; [(y1+y2)*z]/A=0.4-0.7.

In one embodiment, a part by density of the styrene-butadiene-styrene triblock copolymer is greater than or equal to 39. For example, in one embodiment, a part by density of the styrene-butadiene-styrene triblock copolymer is between 39 and 63.

In one embodiment, the resin composition further comprises (i.e., optionally further comprises) polyphenylene ether resin, maleimide resin, styrene maleic anhydride, epoxy resin, cyanate ester resin, maleimide triazine resin, phenolic resin, benzoxazine resin, polyester resin, amine curing agent or a combination thereof.

In one embodiment, the resin composition further comprises flame retardant, curing accelerator, polymerization inhibitor, inorganic filler, surface treating agent, coloring agent, solvent or a combination thereof.

In one embodiment, the resin composition further comprises a crosslinking agent, wherein the crosslinking agent comprises 1,2-bis(vinylphenyl)ethane, bis(vinylbenzyl)ether, divinylbenzene, divinylnaphthalene, divinylbiphenyl, t-butyl styrene, triallyl isocyanurate, triallyl cyanurate, 1,2,4-trivinyl cyclohexane, diallyl bisphenol A, styrene, decadiene, octadiene, vinylcarbazole, acrylate or a combination thereof.

In one embodiment, the resin composition comprises: 100 parts by weight of (A) the polybutadiene and 15 to 55 parts by weight of (B) the styrene-butadiene-styrene triblock copolymer of Formula (1).

In another aspect, the present disclosure provides an article made from the resin composition described above, which comprises a prepreg, a resin film, a laminate or a printed circuit board.

In one embodiment, articles made from the resin composition disclosed herein have one, more or all of the following properties:
a Z-axis ratio of thermal expansion as measured by reference to IPC-TM-650 2.4.24.5 of less than or equal to 1.07%;
no delamination occurs after subjecting the article to a pressure cooking test by reference to IPC-TM-650 2.6.16.1 followed by a thermal resistance test by reference to IPC-TM-650 2.4.23;
a dissipation factor at 10 GHz as measured by reference to JIS C2565 of less than or equal to 0.00161; and
a dissipation factor aging variation under moisture and heat of less than or equal to 35% as calculated according to a dissipation factor at 10 GHz as measured by reference to JIS C2565 before and after the article is placed under a temperature of 85° C. and a relative humidity of 85% for 48 hours.

Methods for measuring the aforesaid properties will be elaborated in detail below.

### DESCRIPTION OF THE EMBODIMENTS

To enable those skilled in the art to further appreciate the features and effects of the present disclosure, words and terms contained in the specification and appended claims are described and defined. Unless otherwise defined, all technical and scientific terms used herein have the same meaning as commonly understood by those of ordinary skill in the art to which this disclosure pertains. In the case of conflict, the present document and definitions contained herein will control.

While some theories or mechanisms may be proposed herein, the present disclosure is not bound by any theories or mechanisms described regardless of whether they are right or wrong, as long as the embodiments can be implemented according to the present disclosure.

As used herein, “a,” “an” or any similar expression is employed to describe components and features of the present disclosure. This is done merely for convenience and to give a general sense of the scope of the present disclosure. Accordingly, this description should be read to include one or at least one and the singular also includes the plural unless it is obvious to mean otherwise.

As used herein, “or a combination thereof” means “or any combination thereof”, and “any” means “any one”, vice versa.

As used herein, the term “encompasses,” “encompassing,” “comprises,” “comprising,” “includes,” “including,” “has,” “having” or any other variant thereof is construed as an open-ended transitional phrase intended to cover a non-exclusive inclusion. For example, a composition or an article of manufacture that comprises a list of elements is not necessarily limited to only those elements but may include other elements not expressly listed or inherent to such composition or article of manufacture. Further, unless expressly stated to the contrary, the term “or” refers to an inclusive or and not to an exclusive or. For example, a condition “A or B” is satisfied by any one of the following: A is true (or present) and B is false (or not present), A is false (or not present) and B is true (or present), and both A and B are true (or present). In addition, whenever open-ended transitional phrases are used, such as “encompasses,” “encompassing,” “comprises,” “comprising,” “includes,” “including,” “has,” “having” or any other variant thereof, it is understood that close-ended transitional phrases such as “consisting of,” “composed by” and “remainder being” and partially open-ended transitional phrases such as “consisting essentially of,” “primarily consisting of,” “mainly consisting of,” “primarily containing,” “composed essentially of,” “essentially having,” etc. are also disclosed and included.

In this disclosure, features and conditions such as values, numbers, contents, amounts or concentrations are presented as a numerical range or a percentage range merely for convenience and brevity. Therefore, a numerical range or a percentage range should be interpreted as encompassing and specifically disclosing all possible subranges and individual numerals or values therein, including integers and fractions, particularly all integers therein. For example, a range of “1.0 to 8.0” or “between 1.0 and 8.0” should be understood as explicitly disclosing all subranges such as 1.0 to 8.0, 1.0 to 7.0, 2.0 to 8.0, 2.0 to 6.0, 3.0 to 6.0, 4.0 to 8.0, 3.0 to 8.0 and so on and encompassing the endpoint values, particularly subranges defined by integers, as well as disclosing all individual values in the range such as 1.0, 2.0, 3.0, 4.0, 5.0, 6.0, 7.0 and 8.0. Unless otherwise defined, the aforesaid interpretation rule should be applied throughout the present disclosure regardless of broadness of the scope.

Whenever amount, concentration or other numeral or parameter is expressed as a range, a preferred range or a series of upper and lower limits, it is understood that all ranges defined by any pair of the upper limit or preferred value and the lower limit or preferred value are specifically disclosed, regardless whether these ranges are explicitly described or not. In addition, unless otherwise defined, whenever a range is mentioned, the range should be interpreted as inclusive of the endpoints and every integers and fractions in the range.

Given the intended purposes and advantages of this disclosure are achieved, numerals or figures have the precision of their significant digits. For example, 40.0 should be understood as covering a range of 39.50 to 40.49.

As used herein, a Markush group or a list of items is used to describe examples or embodiments of the present disclosure. A skilled artisan will appreciate that all subgroups of members or items and individual members or items of the Markush group or list can also be used to describe the present disclosure. For example, when X is described as being “selected from a group consisting of X1, X2 and X3,” it is intended to disclose the situations of X is X1 and X is X1 and/or X2 and/or X3. In addition, when a Markush group or a list of items is used to describe examples or embodiments of the present disclosure, a skilled artisan will understand that any subgroup or any combination of the members or items in the Markush group or list may also be used to describe the present disclosure. Therefore, for example, when X is described as being “selected from a group consisting of X1, X2 and X3” and Y is described as being “selected from a group consisting of Y1, Y2 and Y3,” the disclosure includes any combination of X is X1 and/or X2 and/or X3 and Y is Y1 and/or Y2 and/or Y3.

Unless otherwise specified, according to the present disclosure, a compound refers to a chemical substance formed by two or more elements bonded with chemical bonds and may comprise a small molecule compound and a polymer compound, but not limited thereto. Any compound disclosed herein is interpreted to not only include a single chemical substance but also include a class of chemical substances having the same kind of components or having the same property.

Unless otherwise specified, according to the present disclosure, a polymer refers to the product formed by monomer(s) via polymerization and usually comprises multiple aggregates of polymers respectively formed by multiple repeated simple structure units by covalent bonds; the monomer refers to the compound forming the polymer. A polymer may comprise a homopolymer, a copolymer, a prepolymer, etc., but not limited thereto. A prepolymer refers to a polymer having a lower molecular weight between the molecular weight of monomer and the molecular weight of final polymer, and a prepolymer contains a reactive functional group capable of participating further polymerization to obtain the final polymer product which has been fully crosslinked or cured. The term “polymer” includes but is not limited to an oligomer. An oligomer refers to a polymer with 2-20, typically 2-5, repeating units.

Unless otherwise specified, the term “resin” is a widely used common name of a synthetic polymer and is construed in the present disclosure as comprising monomer and its combination, polymer and its combination or a combination of monomer and its polymer, but not limited thereto.

Unless otherwise specified, according to the present disclosure, a modification comprises a product derived from a resin with its reactive functional group modified, a product derived from a prepolymerization reaction of a resin and other resins, a product derived from a crosslinking reaction of a resin and other resins, a product derived from homopolymerizing a resin, a product derived from copolymerizing a resin and other resins, etc.

The unsaturated bond described herein, unless otherwise specified, refers to a reactive unsaturated bond, such as but not limited to an unsaturated double bond with the potential of being crosslinked with other functional groups, such as an unsaturated carbon-carbon double bond with the potential of being crosslinked with other functional groups, but not limited thereto.

Unless otherwise specified, in the present disclosure, the term “vinyl-containing” is construed to encompass the inclusion of a vinyl group, a vinylene group, an allyl group, a (meth)acrylate group or a combination thereof.

Unless otherwise specified, according to the present disclosure, when the term acrylate is expressed as (meth)acrylate, it is intended to comprise both situations of containing and not containing a methyl group; for example, (meth)acrylate is construed as including acrylate and methacrylate.

Unless otherwise specified, an alkyl group, an alkenyl group and a hydrocarbyl group described herein are construed to encompass various isomers thereof. For example, a propyl group is construed to encompass n-propyl and iso-propyl.

Unless otherwise specified, as used herein, part(s) by weight represents weight part(s) in any weight unit, such as but not limited to kilogram, gram, pound and so on. For example, 100 parts by weight of the maleimide resin may represent 100 kilograms of the maleimide resin or 100 pounds of the maleimide resin.

It should be understood that all features disclosed herein may be combined in any way to constitute the technical solution of the present disclosure, as long as there is no conflict present in the combination of these features.

Examples and embodiments are described in detail below. It will be understood that these examples and embodiments are exemplary only and are not intended to limit the scope and use of the present disclosure. Unless otherwise specified, processes, reagents and conditions described in the examples are those known in the art.

As described above, it is a primary object of the present disclosure to provide a resin composition, comprising: (A) a polybutadiene having a content of 1,2-vinyl group of greater than or equal to 85%; and (B) a styrene-butadiene-styrene triblock copolymer of Formula (1) comprising a butadiene block having a content of 1,2-vinyl group of greater than or equal to 80%:

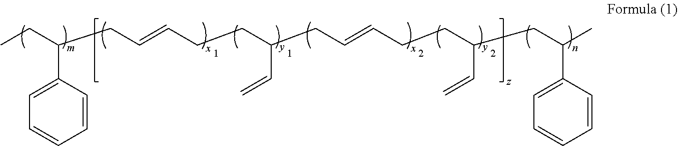

wherein x1, x2, y1 and y2 are each independently an integer of greater than or equal to 0, y1 and y2 are not 0 at the same time, and m, n and z are each independently an integer of greater than or equal to 1, and wherein:
m+n+(x1+x2)*z+(y1+y2)*z=A; m/A=0.1-0.4; n/A=0.1-0.4; [(x1+x2)*z]/A=0-0.1; [(y1+y2)*z]/A=0.4-0.7.

In one embodiment, for example, the polybutadiene described herein is a butadiene homopolymer. During the polymerization process, butadiene monomers may be polymerized as cis 1,4-addition, trans 1,4-addition or 1,2-addition configuration, so the product polybutadiene may contain monomer units of cis 1,4-addition units, trans 1,4-addition units or 1,2-addition units. As the first main component of the resin composition disclosed herein, the polybutadiene according to the present disclosure refers to a polybutadiene in which the content of 1,2-addition units (i.e., content of 1,2-vinyl group) accounts for 85% or more of all units, i.e., the polybutadiene according to the present disclosure has a content of 1,2-vinyl group of greater than or equal to 85%.

In one embodiment, for example, the polybutadiene has a content of 1,2-vinyl group of greater than or equal to 90%; in another embodiment, the polybutadiene has a content of 1,2-vinyl group of greater than or equal to 85% and less than or equal to 95%; in still another embodiment, the polybutadiene has a content of 1,2-vinyl group of greater than or equal to 90% and less than or equal to 95%, but not limited thereto.

In one embodiment, for example, the polybutadiene (A) may comprise B-1000, B-2000 or B-3000 available from Nippon Soda Co., Ltd., but not limited thereto.

Unless otherwise specified, according to the present disclosure, the content of 1,2-vinyl group of a compound may be determined by any conventional vinyl group measurement apparatus known in the art, including but not limited to infrared spectroscopy (FTIR), nuclear magnetic resonance (NMR), etc. For example, FTIR may be used for quantitative analysis of the absorption peak area of 1,2-vinyl group and 1,4-vinyl group of butadiene, wherein the characteristic peak of 1,2-vinyl group appears at about 910 cm⁻¹, the characteristic peak of cis 1,4-vinyl group appears at about 738 cm⁻¹, and the characteristic peak of trans1,4-vinyl group appears at about 967 cm⁻¹. Molar attenuation coefficient of each of the three different vinyl groups may be searched and used to calculate the corresponding concentration by dividing the absorption peak area by the respective molar attenuation coefficient, thereby determining the content of 1,2-vinyl group (concentration ratio of 1,2-vinyl group).

As the second main component of the resin composition disclosed herein, the styrene-butadiene-styrene triblock copolymer according to the present disclosure has a structure of Formula (1) shown above, and the butadiene block thereof has a content of 1,2-vinyl group of greater than or equal to 80%.

In one embodiment, for example, the styrene-butadiene-styrene triblock copolymer according to the present disclosure comprises a butadiene block having a content of 1,2-vinyl group of greater than or equal to 80%, greater than or equal to 85%, greater than or equal to 90% or greater than or equal to 95%, but not limited thereto. For example, in the styrene-butadiene-styrene triblock copolymer according to the present disclosure, the content of 1,2-vinyl group in the butadiene block is between 80% and 100%.

In addition, as known by a person having ordinary skill in the art, linear copolymers formed by two different monomers can be categorized into four different types: 1) random copolymer, such as a structure of -AABABBBAAABBA-; 2) alternating copolymer, such as a structure of -ABABABAB-; 3) graft copolymer, such as a structure of -AA(A-BBBB)AA(A-BBBB)AAA-; and 4) block copolymer, such as a structure of -AAAAA-BBBBBB-AAAAA-. In the four categories, random copolymer and alternating copolymer may be produced by a person having ordinary skill in the art using a known copolymerization reaction. In contrast, graft copolymer and block copolymer, in terms of synthesis routes or copolymer properties, are substantially different from random copolymer and alternating copolymer and are therefore not easily exchangeable or replaceable by random copolymer or alternating copolymer. For example, styrene-butadiene rubber is a random copolymer of butadiene and styrene and is generally formed by emulsion polymerization. The butadiene units comprise mostly trans 1,4-vinyl groups, and its physical and mechanical performance and processibility are similar to natural rubber. On the other hand, styrene-butadiene-styrene triblock copolymer belongs to a SBS thermoplastic elastomer, wherein S represents a styrene chain, and B represents a butadiene chain; its synthesis involves using an alkyllithium/alkane system to proceed active anion solution polymerization, which generally requires a massive amount of creative work to control the chain length to adjust its property; therefore, in terms of synthesis routes or copolymer properties, it is substantially different from random copolymer and alternating copolymer.

In one embodiment, for example, a part by density of the styrene-butadiene-styrene triblock copolymer according to the present disclosure is greater than or equal to 39. In some embodiments, preferably, a part by density of the styrene-butadiene-styrene triblock copolymer is between 39 and 66. For example, in some embodiments, a part by density of the styrene-butadiene-styrene triblock copolymer is between 39 and 63.

According to the present disclosure, the part(s) by density of the styrene-butadiene-styrene triblock copolymer is calculated from the density of the styrene-butadiene-styrene triblock copolymer multiplied by the content of 1,2-vinyl group of the styrene-butadiene-styrene triblock copolymer and then multiplied by 100, and part(s) by density is rounded up to the nearest integer with its unit omitted. According to the present disclosure, unless otherwise specified, the density of the styrene-butadiene-styrene triblock copolymer can be ascertained by any known density measurement method, such as the measurement process described in ASTM D4025. In addition, according to the present disclosure, the content of 1,2-vinyl group of the styrene-butadiene-styrene triblock copolymer is equal to the content of 1,2-vinyl group of the butadiene block in the styrene-butadiene-styrene triblock copolymer multiplied by the percentage of the butadiene block in the styrene-butadiene-styrene triblock copolymer.

Inventors of this application studied the relationship between the density of the styrene-butadiene-styrene triblock copolymer, the content of 1,2-vinyl group of the copolymer and the copolymer properties and found that, in one embodiment, for example, if the polybutadiene has a content of 1,2-vinyl group of greater than or equal to 85%, the butadiene block in the styrene-butadiene-styrene triblock copolymer has a content of 1,2-vinyl group of greater than or equal to 80%, and the part by density of the styrene-butadiene-styrene triblock copolymer is greater than or equal to 39, the present disclosure may preferably achieve at the same time the desirable properties including low Z-axis ratio of thermal expansion, no delamination in a test of thermal resistance after moisture absorption, low dissipation factor, and low dissipation factor aging variation under moisture and heat.

In addition to the aforesaid (A) polybutadiene and (B) styrene-butadiene-styrene triblock copolymer of Formula (1), the resin composition according to the present disclosure may optionally further comprise other components.

In one embodiment, for example, the resin composition according to the present disclosure may further comprise polyphenylene ether resin, maleimide resin, styrene maleic anhydride, epoxy resin, cyanate ester resin, maleimide triazine resin, phenolic resin, benzoxazine resin, polyester resin, amine curing agent or a combination thereof.

According to the present disclosure, the polyphenylene ether resin may comprise a vinyl-containing polyphenylene ether resin, and the vinyl-containing polyphenylene ether resin may comprise a vinylbenzyl-containing polyphenylene ether resin, a methacrylate-containing polyphenylene ether resin, an allyl-containing polyphenylene ether resin, a vinylbenzyl-modified bisphenol A polyphenylene ether resin, a chain-extended vinyl-containing polyphenylene ether resin or a combination thereof.

For example, the vinyl-containing polyphenylene ether resin may be a vinylbenzyl-containing polyphenylene ether resin with a number average molecular weight of about 1200 (such as OPE-2st 1200, available from Mitsubishi Gas Chemical Co., Inc.), a vinylbenzyl-containing polyphenylene ether resin with a number average molecular weight of about 2200 (such as OPE-2st 2200, available from Mitsubishi Gas Chemical Co., Inc.), a methacrylate-containing polyphenylene ether resin with a number average molecular weight of about 1900 to 2300 (such as SA9000, available from Sabic), a vinylbenzyl-modified bisphenol A polyphenylene ether resin with a number average molecular weight of about 2400 to 2800, a chain-extended vinyl-containing polyphenylene ether resin with a number average molecular weight of about 2200 to 3000, or a combination thereof. The chain-extended vinyl-containing polyphenylene ether resin may include various polyphenylene ether resins disclosed in the US Patent Application Publication No. 2016/0185904 A1, all of which are incorporated herein by reference in their entirety.

As used herein, for example, the maleimide resin refers to a compound, monomer, mixture, or polymer (including oligomer) containing at least one maleimide group. Unless otherwise specified, the maleimide resin used in the present disclosure is not particularly limited and may include any one or more maleimide resins useful for preparing a prepreg, a resin film, a laminate or a printed circuit board. Examples include but are not limited to 4,4′-diphenylmethane bismaleimide, oligomer of phenylmethane maleimide (a.k.a. polyphenylmethane maleimide), m-phenylene bismaleimide, bisphenol A diphenyl ether bismaleimide, 3,3′-dimethyl-5,5′-diethyl-4,4′-diphenyl methane bismaleimide, 4-methyl-1,3-phenylene bismaleimide, 1,6-bismaleimide-(2,2,4-trimethyl)hexane, N-2,3-xylylmaleimide, N-2,6-xylylmaleimide, N-phenyl maleimide, maleimide compound containing aliphatic long-chain structure or a combination thereof. In addition, unless otherwise specified, the aforesaid maleimide resin of the present disclosure may comprise a prepolymer thereof, such as a prepolymer of diallyl compound and maleimide compound, a prepolymer of diamine and maleimide compound, a prepolymer of multi-functional amine and maleimide compound or a prepolymer of acid phenol compound and maleimide compound, but not limited thereto.

For example, the maleimide resin used herein may include products such as BMI-1000, BMI-1000H, BMI-1100, BMI-1100H, BMI-2000, BMI-2300, BMI-3000, BMI-3000H, BMI-4000H, BMI-5000, BMI-5100, BM-7000 and BMI-7000H available from Daiwakasei Industry Co., Ltd., or products such as BMI-70 and BMI-80 available from K.I Chemical Industry Co., Ltd.

For example, the maleimide resin containing aliphatic long-chain structure may include products such as BMI-689, BMI-1400, BMI-1500, BMI-1700, BMI-2500, BMI-3000, BMI-5000 and BMI-6000 available from Designer Molecules Inc.

According to the present disclosure, for example, the styrene maleic anhydride may be any styrene maleic anhydrides known in the field to which this disclosure pertains, wherein the ratio of styrene (S) to maleic anhydride (MA) may be for example 1/1, 2/1, 3/1, 4/1, 6/1, 8/1 or 12/1, examples including styrene maleic anhydride copolymers such as SMA-1000, SMA-2000, SMA-3000, EF-30, EF-40, EF-60 and EF-80 available from Cray Valley, or styrene maleic anhydride copolymers such as C400, C500, C700 and C900 available from Polyscope, but not limited thereto.

According to the present disclosure, for example, the epoxy resin may be any epoxy resins known in the field to which this disclosure pertains; in terms of improving the thermal resistance of the resin composition, the epoxy resin may include, but not limited to, bisphenol A epoxy resin, bisphenol F epoxy resin, bisphenol S epoxy resin, bisphenol AD epoxy resin, novolac epoxy resin, trifunctional epoxy resin, tetrafunctional epoxy resin, multifunctional novolac epoxy resin, dicyclopentadiene (DCPD) epoxy resin, phosphorus-containing epoxy resin, p-xylene epoxy resin, naphthalene epoxy resin (e.g., naphthol epoxy resin), benzofuran epoxy resin, isocyanate-modified epoxy resin, or a combination thereof. The novolac epoxy resin may be phenol novolac epoxy resin, bisphenol A novolac epoxy resin, bisphenol F novolac epoxy resin, biphenyl novolac epoxy resin, phenol benzaldehyde epoxy resin, phenol aralkyl novolac epoxy resin or o-cresol novolac epoxy resin. The phosphorus-containing epoxy resin may be DOPO (9,10-dihydro-9-oxa-10-phosphaphenanthrene-10-oxide) epoxy resin, DOPO-HQ epoxy resin or a combination thereof. The DOPO epoxy resin may be any one or more selected from DOPO-containing phenol novolac epoxy resin, DOPO-containing cresol novolac epoxy resin and DOPO-containing bisphenol-A novolac epoxy resin; the DOPO-HQ epoxy resin may be any one or more selected from DOPO-HQ-containing phenol novolac epoxy resin, DOPO-HQ-containing cresol novolac epoxy resin and DOPO-HQ-containing bisphenol-A novolac epoxy resin, but not limited thereto.

According to the present disclosure, for example, the cyanate ester resin may include any one or more cyanate ester resins useful for preparing a prepreg, a resin film, a laminate or a printed circuit board, such as a compound having an Ar—O—C≡N structure, wherein Ar may be a substituted or unsubstituted aromatic group. In terms of improving the thermal resistance of the resin composition, examples of the cyanate ester resin include but are not limited to novolac cyanate ester resin, bisphenol A cyanate ester resin, bisphenol F cyanate ester resin, dicyclopentadiene-containing cyanate ester resin, naphthalene-containing cyanate ester resin, phenolphthalein cyanate ester resin, adamantane cyanate ester resin, fluorene cyanate ester resin or a combination thereof. The novolac cyanate ester resin may be bisphenol A novolac cyanate ester resin, bisphenol F novolac cyanate ester resin or a combination thereof. For example, the cyanate ester resin may be available under the product name Primaset PT-15, PT-30S, PT-60S, BA-200, BA-230S, BA-3000S, BTP-2500, BTP-6020S, DT-4000, DT-7000, ULL950S, HTL-300, CE-320, LUT-50, or LeCy sold by Lonza.

For example, unless otherwise specified, the maleimide triazine resin used in the present disclosure is not particularly limited and may include any one or more maleimide triazine resins useful for preparing a prepreg, a resin film, a laminate or a printed circuit board. For example, the maleimide triazine resin may be obtained by polymerizing the aforesaid cyanate ester resin and the aforesaid maleimide resin. For example, the maleimide triazine resin may be obtained by polymerizing bisphenol A cyanate ester resin and maleimide resin, by polymerizing bisphenol F cyanate ester resin and maleimide resin, by polymerizing phenol novolac cyanate ester resin and maleimide resin or by polymerizing dicyclopentadiene-containing cyanate ester resin and maleimide resin, but not limited thereto.

For example, the maleimide triazine resin may be obtained by polymerizing the cyanate ester resin and the maleimide resin at any molar ratio. For example, relative to 1 mole of the maleimide resin, 1 to 10 moles of the cyanate ester resin may be used. For example, relative to 1 mole of the maleimide resin, 1, 2, 4, or 6 moles of the cyanate ester resin may be used, but not limited thereto.

According to the present disclosure, for example, the phenolic resin may be any phenolic resins known in the field to which this disclosure pertains, including but not limited to phenoxy resin or novolac resin (such as phenol novolac resin, naphthol novolac resin, biphenyl novolac resin, and dicyclopentadiene phenol resin), but not limited thereto.

According to the present disclosure, for example, the benzoxazine resin may be any benzoxazine resins known in the field to which this disclosure pertains. Examples include but are not limited to bisphenol A benzoxazine resin, bisphenol F benzoxazine resin, phenolphthalein benzoxazine resin, dicyclopentadiene benzoxazine resin, phosphorus-containing benzoxazine resin, dianiline benzoxazine resin and phenyl-modified, vinyl-modified or allyl-modified benzoxazine resin. Commercially available products include LZ-8270 (phenolphthalein benzoxazine resin), LZ-8298 (phenolphthalein benzoxazine resin), LZ-8280 (bisphenol F benzoxazine resin) and LZ-8290 (bisphenol A benzoxazine resin) available from Huntsman, and KZH-5031 (vinyl-modified benzoxazine resin) and KZH-5032 (phenyl-modified benzoxazine resin) available from Kolon Industries Inc. The dianiline benzoxazine resin may be diaminodiphenylmethane benzoxazine resin, diaminodiphenyl ether benzoxazine resin, diaminodiphenyl sulfone benzoxazine resin, diaminodiphenyl sulfide benzoxazine resin or a combination thereof, but not limited thereto.

According to the present disclosure, for example, the polyester may be any polyesters known in the field to which this disclosure pertains. Examples of the polyester include but are not limited to a dicyclopentadiene-containing polyester and a naphthalene-containing polyester. Examples include, but not limited to, HPC-8000 or HPC-8150 available from D.I.C. Corporation.

According to the present disclosure, for example, the amine curing agent may be any amine curing agents known in the field to which this disclosure pertains. Examples include but are not limited to any one or a combination of diamino diphenyl sulfone, diamino diphenyl methane, diamino diphenyl ether, diamino diphenyl sulfide and dicyandiamide (DICY).

In one embodiment, for example, the resin composition according to the present disclosure further comprises flame retardant, curing accelerator, polymerization inhibitor, inorganic filler, surface treating agent, coloring agent, solvent or a combination thereof.

In one embodiment, for example, a suitable flame retardant may be any one or more flame retardants used for preparing a prepreg, a resin film, a laminate or a printed circuit board, including but not limited to a phosphorus-containing flame retardant or a bromine-containing flame retardant.

For example, the phosphorus-containing flame retardant may be, but not limited to, a DPPO compound (e.g., di-DPPO compound), a DOPO compound (e.g., di-DOPO compound), a DOPO resin (e.g., DOPO-HQ, DOPO-NQ, DOPO-PN, and DOPO-BPN), and a DOPO-containing epoxy resin, wherein DOPO-PN is a DOPO-containing phenol novolac compound, and DOPO-BPN may be a DOPO-containing bisphenol novolac compound, such as DOPO-BPAN (DOPO-bisphenol A novolac), DOPO-BPFN (DOPO-bisphenol F novolac) and DOPO-BPSN (DOPO-bisphenol S novolac).

In one embodiment, for example, the curing accelerator (including curing initiator) suitable for the present disclosure may comprise a catalyst, such as a Lewis base or a Lewis acid. The Lewis base may comprise any one or more of imidazole, boron trifluoride-amine complex, ethyltriphenyl phosphonium chloride, 2-methylimidazole (2MI), 2-phenyl-1H-imidazole (2PZ), 2-ethyl-4-methylimidazole (2E4MI), triphenylphosphine (TPP) and 4-dimethylaminopyridine (DMAP). The Lewis acid may comprise metal salt compounds, such as those of manganese, iron, cobalt, nickel, copper and zinc, such as zinc octanoate or cobalt octanoate. The curing accelerator also includes a curing initiator, such as a peroxide capable of producing free radicals, examples of curing initiator including but not limited to dicumyl peroxide, tert-butyl peroxybenzoate, dibenzoyl peroxide (BPO), 2,5-dimethyl-2,5-di(tert-butyl peroxy)-3-hexyne (25B), bis(tert-butylperoxyisopropyl)benzene or a combination thereof.

In one embodiment, for example, the polymerization inhibitor suitable for the present disclosure may comprise, but not limited to, 1,1-diphenyl-2-picrylhydrazyl radical, methyl acrylonitrile, 2,2,6,6-tetramethyl-1-oxo-piperidine, dithioester, nitroxide-mediated radical, triphenylmethyl radical, metal ion radical, sulfur radical, hydroquinone, 4-methoxyphenol, p-benzoquinone, phenothiazine, β-phenylnaphthyl amine, 4-t-butylcatechol, methylene blue, 4,4′-butylidenebis(6-t-butyl-3-methylphenol), 2,2′-methylenebis(4-ethyl-6-t-butylphenol) or a combination thereof. For example, the polymerization inhibitor suitable for the present disclosure may include products derived from the polymerization inhibitor with its hydrogen atom or group substituted by other atom or group. Examples include products derived from a polymerization inhibitor with its hydrogen atom substituted by an amino group, a hydroxyl group, a carbonyl group or the like.

In one embodiment, for example, the inorganic filler suitable for the present disclosure may include, but not limited to, silica (fused, non-fused, porous or hollow type), aluminum oxide, aluminum hydroxide, magnesium oxide, magnesium hydroxide, calcium carbonate, aluminum nitride, boron nitride, aluminum silicon carbide, silicon carbide, titanium dioxide, barium titanate, lead titanate, strontium titanate, calcium titanate, magnesium titanate, barium zirconate, lead zirconate, magnesium zirconate, lead zirconate titanate, zinc molybdate, calcium molybdate, magnesium molybdate, zinc molybdate-modified talc, zinc oxide, zirconium oxide, mica, boehmite (A100H), calcined talc, talc, silicon nitride, calcined kaolin, or a combination thereof. Moreover, the inorganic filler can be spherical (including solid sphere or hollow sphere), fibrous, plate-like, particulate, sheet-like or whisker-like and can be optionally pretreated by a silane coupling agent.

In one embodiment, for example, the surface treating agent suitable for the present disclosure comprises silane coupling agent, organosilicon oligomer, titanate coupling agent or a combination thereof. The addition of the surface treating agent may promote the dispersivity of the inorganic filler and the compatibility with resin components. For example, the silane coupling agent may comprise silane (such as but not limited to siloxane) and may be further categorized according to the functional groups into amino silane, epoxide silane, vinyl silane, acrylate silane, methacrylate silane, hydroxyl silane, isocyanate silane, methacryloxy silane and acryloxy silane.

In one embodiment, for example, the coloring agent suitable for the present disclosure may comprise, but not limited to, dye or pigment.

In one embodiment, for example, the solvent suitable for the present disclosure may comprise, but not limited to, methanol, ethanol, ethylene glycol monomethyl ether, acetone, butanone (a.k.a. methyl ethyl ketone), methyl isobutyl ketone, cyclohexanone, toluene, xylene, methoxyethyl acetate, ethoxyethyl acetate, propoxyethyl acetate, ethyl acetate, dimethylformamide, dimethylacetamide, propylene glycol methyl ether, or a mixture thereof.

In one embodiment, for example, the resin composition according to the present disclosure further comprises a crosslinking agent. For example, the crosslinking agent comprises 1,2-bis(vinylphenyl)ethane, bis(vinylbenzyl)ether, divinylbenzene, divinylnaphthalene, divinylbiphenyl, t-butyl styrene, triallyl isocyanurate, triallyl cyanurate, 1,2,4-trivinyl cyclohexane, diallyl bisphenol A, styrene, decadiene, octadiene, vinylcarbazole, acrylate or a combination thereof.

In addition to the aforesaid components, the resin composition disclosed herein may optionally further comprise other components.

In one embodiment, for example, the resin composition disclosed herein may further comprise core-shell rubber, ethylene propylene rubber or a combination thereof.

Unless otherwise specified, the amount of each component used in the resin composition disclosed herein is not particularly limited and may be adjusted according to the need. In one embodiment, for example, the resin composition disclosed herein may comprise 100 parts by weight of (A) the polybutadiene and 15 to 55 parts by weight of (B) the styrene-butadiene-styrene triblock copolymer of Formula (1). For example, relative to 100 parts by weight of (A) the polybutadiene, the resin composition disclosed herein may comprise 15, 25, 35, 45 or 55 parts by weight of (B) the styrene-butadiene-styrene triblock copolymer of Formula (1), but not limited thereto.

The resin composition of various embodiments may be processed to make different articles, such as those suitable for use as components in electronic products, including but not limited to a prepreg, a resin film, a laminate or a printed circuit board.

For example, the resin composition according to each of the various embodiments disclosed herein may be used to make a prepreg, which has a reinforcement material and a layered structure formed thereon, wherein the layered structure is made by heating the resin composition at high temperature to a semi-cured state (B-stage). Suitable baking temperature for making the prepreg may be for example 120° C. to 180° C. For example, the reinforcement material may be any one of a fiber material, woven fabric, and non-woven fabric, and the woven fabric preferably comprises fiberglass fabrics. Types of fiberglass fabrics are not particularly limited and may be any commercial fiberglass fabric useful for various printed circuit boards, such as E-glass fiber fabric, D-glass fiber fabric, S-glass fiber fabric, T-glass fiber fabric, L-glass fiber fabric or Q-glass fiber fabric, wherein the fiber may comprise yarns and rovings, in spread form or standard form. Non-woven fabric preferably comprises liquid crystal polymer non-woven fabric, such as polyester non-woven fabric, polyurethane non-woven fabric and so on, but not limited thereto. Woven fabric may also comprise liquid crystal polymer woven fabric, such as polyester woven fabric, polyurethane woven fabric and so on, but not limited thereto. The reinforcement material may increase the mechanical strength of the prepreg. In one preferred embodiment, the reinforcement material can be optionally pre-treated by a silane coupling agent. The prepreg may be further heated and cured to the C-stage to form an insulation layer.

In one embodiment, by well mixing the resin composition to form a varnish, loading the varnish into an impregnation tank, impregnating a fiberglass fabric into the impregnation tank to adhere the resin composition onto the fiberglass fabric, and proceeding with heating and baking at a proper temperature to a semi-cured state, a prepreg may be obtained.

For example, the resin composition from each embodiment of the present disclosure can be used to make a resin film, which is prepared by heating and baking the resin composition to the semi-cured state. For example, by selectively coating the resin composition from each embodiment of the present disclosure on a liquid crystal polymer film, a polyethylene terephthalate film (PET film) or a polyimide film, followed by heating and baking at a proper temperature to a semi-cured state, a resin film may be obtained. For example, the resin composition from each embodiment may be coated on a copper foil to uniformly adhere the resin composition thereon, followed by heating and baking at a proper temperature to a semi-cured state to obtain the resin film.

For example, the resin composition from each embodiment of the present disclosure may be made into a laminate, which comprises at least two metal foils and at least one insulation layer disposed between the metal foils, wherein the insulation layer is made by curing the resin composition at high temperature and high pressure to the C-stage, a suitable curing temperature being for example between 200° C. and 320° C. and preferably between 230° C. and 300° C. and a suitable curing time being 100 to 300 minutes and preferably 120 to 250 minutes. The insulation layer may be obtained by curing the aforesaid prepreg or resin film. The metal foil may contain copper, aluminum, nickel, platinum, silver, gold or alloy thereof, such as a copper foil. In a preferred embodiment, the laminate is a copper-clad laminate.

For example, the resin compositions of various embodiments of the present disclosure may be used to make a printed circuit board. In one embodiment of making the printed circuit board according to the present disclosure, a double-sided copper-clad laminate (such as product EM-827, available from Elite Material Co., Ltd.) with a thickness of 28 mil and having 1-ounce (oz) HTE (high temperature elongation) copper foils may be used and subject to drilling and then electroplating, so as to form electrical conduction between the top layer copper foil and the bottom layer copper foil. Then the top layer copper foil and the bottom layer copper foil are etched to form inner layer circuits. Then brown oxidation and roughening are performed on the inner layer circuits to form uneven structures on the surface to increase roughness. Next, a vacuum lamination apparatus is used to laminate the assembly containing a copper foil, the prepreg, the inner layer circuits, the prepreg and a copper foil stacked in said order by heating at 200° C. to 320° C. for 100 to 300 minutes to cure the insulation material of the prepregs. Next, black oxidation, drilling, copper plating and other known circuit board processes are performed on the outmost copper foils so as to obtain the printed circuit board.

Preferably, the resin composition of the present disclosure or the article made therefrom may achieve improvement in one or more of the following properties: Z-axis ratio of thermal expansion, thermal resistance after moisture absorption, dissipation factor, and dissipation factor aging variation under moisture and heat.

For example, the resin composition according to the present disclosure or the article made therefrom may achieve one, more or all of the following properties:
a Z-axis ratio of thermal expansion as measured by reference to IPC-TM-650 2.4.24.5 of less than or equal to 1.07%, such as between 0.88% and 1.07%;
no delamination occurs after subjecting the article to a pressure cooking test by reference to IPC-TM-650 2.6.16.1 followed by a thermal resistance test by reference to IPC-TM-650 2.4.23;
a dissipation factor at 10 GHz as measured by reference to JIS C2565 of less than or equal to 0.00161, such as between 0.00146 and 0.00161;
a dissipation factor aging variation under moisture and heat of less than or equal to 35%, such as between 21% and 35%, as calculated according to a dissipation factor at 10 GHz as measured by reference to JIS C2565 before and after the article is placed under a temperature of 85° C. and a relative humidity of 85% for 48 hours.

Raw materials below were used to prepare the resin compositions of various Examples and Comparative Examples of the present disclosure according to the amount listed in Table 1 to Table 4 and further fabricated to prepare test samples.

Materials and reagents used in Preparation Examples, Examples and Comparative Examples disclosed herein are listed below:
B-3000: polybutadiene (PB), content of 1,2-vinyl group ≥90%, available from Nippon Soda Co., Ltd.
B-1000: polybutadiene (PB), content of 1,2-vinyl group ≥85%, available from Nippon Soda Co., Ltd.
B-2000: polybutadiene (PB), content of 1,2-vinyl group ≥90%, available from Nippon Soda Co., Ltd.
Ricon130: polybutadiene (PB), number average molecular weight (Mn) of about 2500, content of 1,2-vinyl group of about 28%, available from CRAY VALLEY.
Self-made SBS1: styrene-butadiene-styrene triblock copolymer, prepared by Applicant, having a density of 0.97 gm/cc, a styrene content of 50%, and a content of 1,2-vinyl group of the butadiene block of 80%, as described in Preparation Example 1. In the self-made SBS1, the content of 1,2-vinyl group is 40% (i.e., equal to the content of 1,2-vinyl group (80%) of the butadiene block multiplied by the content of butadiene (100% minus 50%)); as calculated according to the formulas described in the present disclosure, the part by density of the self-made SBS1 is 39 (part by density is equal to density (0.97) multiplied by the content of 1,2-vinyl group (40%) of the self-made SBS1 and multiplied by 100).
NISSO-SBS: styrene-butadiene-styrene triblock copolymer, having a number average molecular weight (Mn) of about 44000, a density of 0.96 gm/cc, a styrene content of 45%, and a content of 1,2-vinyl group of the butadiene block of 91%, available from Nippon Soda Co., Ltd. As calculated according to the formulas described in the present disclosure, the part by density is 48.
Self-made SBS2: styrene-butadiene-styrene triblock copolymer, prepared by Applicant, having a content of 1,2-vinyl group of the butadiene block of 95%, as described in Preparation Example 2.
D1118: mixture of styrene-butadiene-styrene triblock copolymer and styrene-butadiene diblock copolymer, having a number average molecular weight (Mn) of about 100000, a density of 0.94 gm/cc, a styrene content of 33%, and a content of 1,2-vinyl group of the butadiene block of 4%, available from Kraton. As calculated according to the formulas described in the present disclosure, the part by density is 3.
YH-792: styrene-butadiene-styrene triblock copolymer, having a number average molecular weight (Mn) of about 95000, a density of 0.96 gm/cc, a styrene content of 40%, and a content of 1,2-vinyl group of the butadiene block of 15%, available from Yueyang Petrochemical Co., Ltd. As calculated according to the formulas described in the present disclosure, the part by density is 9.
H1043: hydrogenated styrene-butadiene-styrene triblock copolymer, having a number average molecular weight (Mn) of about 54000, a density of 0.97 gm/cc, a styrene content of 67%, available from Asahi, wherein the vinyl groups of the copolymer have been completely hydrogenated and therefore the content of 1,2-vinyl group is 0, and the part by density is 0.
SA9000: methacrylate-containing polyphenylene ether resin, number average molecular weight (Mn) of about 1900 to 2300, available from Sabic.
TAIC: triallyl isocyanurate, commercially available.
SC-2500 SVJ: spherical silica pre-treated by silane coupling agent, available from Admatechs.
25B: 2,5-dimethyl-2,5-di(t-butylperoxy)-3-hexyne, available from NOF Corporation. BIBP: di(t-butyl)peroxyisopropylbenzene, available from J&K Scientific Ltd. Toluene: commercially available.

A proper amount (abbreviated as “PA”) in Tables 1˜4 represents an amount of solvent suitable for obtaining a desired solid content for the resin composition, such as a solid content of the varnish in Tables 1˜4 being 65 wt %.

### Preparation Example 1

To a drying reactor equipped with a stirrer and a jacket, a solution of 100 g of styrene in cyclohexane was added in the presence of nitrogen protection. Under stirring, a solution of 6 mmol of n-butyllithium in cyclohexane, 15 mmol of tetrahydrofurfuryl ethyl ether, 4.5 mmol of tetramethylethylenediamine, and 10 mmol of dipiperidinoethane were added and polymerized at 40° C. for 1 hour. Then a solution of 200 g of butadiene in cyclohexane was added slowly for further reaction for 1 hour. Then a solution of 100 g of styrene in cyclohexane was added for further polymerization for 80 minutes. Ethanol in an amount of at least 5 times of the mixture solution was added to terminate the reaction, followed by precipitation, suction filtration and 24 hours of vacuum drying to obtain a styrene-butadiene-styrene triblock copolymer SBS1, having a density of 0.97 gm/cc, a styrene content of 50%, and a content of 1,2-vinyl group of the butadiene block of 80%. As calculated according to the formulas described in the present disclosure, the part by density of SBS1 is 39.

### Preparation Example 2

To a drying reactor equipped with a stirrer and a jacket, a solution of 60 g of styrene in cyclohexane was added in the presence of nitrogen protection. Under stirring, a solution of 6 mmol of n-butyllithium in cyclohexane, 15 mmol of tetrahydrofurfuryl ethyl ether, 4.5 mmol of tetramethylethylenediamine, and 10 mmol of dipiperidinoethane were added and polymerized at 40° C. for 1 hour. Then a solution of 280 g of butadiene in cyclohexane was added slowly for further reaction for 1 hour. Then a solution of 60 g of styrene in cyclohexane was added for further polymerization for 80 minutes. Ethanol in an amount of at least 5 times of the mixture solution was added to terminate the reaction, followed by precipitation, suction filtration and 24 hours of vacuum drying to obtain a styrene-butadiene-styrene triblock copolymer SBS2, having a density of 0.94 gm/cc, a styrene content of 30%, and a content of 1,2-vinyl group of the butadiene block of 95%; as calculated according to the formulas described in the present disclosure, the part by density of SBS2 is 63.

Samples (specimens) were prepared as described below and tested and analyzed under specified conditions below.
1. Prepreg: Resin composition from each Example or each Comparative Example was well-mixed to form a varnish, which was then loaded to an impregnation tank; a fiberglass fabric (e.g., 1080 L-glass fiber fabric, available from Asahi) was impregnated into the impregnation tank to adhere the resin composition onto the fiberglass fabric, followed by heating and baking to obtain a prepreg.
2. Copper-clad laminate (6-ply, formed by lamination of six prepregs): Two 18 μm RTF copper foils (reverse treated copper foils) and six prepregs obtained from 1080 L-glass fiber fabrics impregnated with each Example or Comparative Example and having a resin content of about 80% were prepared and stacked in the order of one RTF copper foil, six prepregs and one RTF copper foil, followed by lamination under vacuum at 35 kgf/cm² pressure and 250° C. for 4 hours to form a copper-clad laminate. Insulation layers were formed after curing six prepregs between the two copper foils.
3. Copper-free laminate (6-ply, formed by lamination of six prepregs): Each aforesaid copper-clad laminate was etched to remove the copper foils on both sides to obtain a copper-free laminate (6-ply), which is formed by laminating six prepregs.
4. Copper-clad laminate (2-ply, formed by lamination of two prepregs): Two 18 μm RTF copper foils (reverse treated copper foils) and two prepregs obtained from 1080 L-glass fiber fabrics impregnated with each Example or Comparative Example and having a resin content of about 80% were prepared and stacked in the order of one RTF copper foil, two prepregs and one RTF copper foil, followed by lamination under vacuum at 35 kgf/cm² pressure and 250° C. for 4 hours to form a copper-clad laminate. Insulation layers were formed after curing two prepregs between the two copper foils.
5. Copper-free laminate (2-ply, formed by lamination of two prepregs): Each aforesaid copper-clad laminate was etched to remove the copper foils on both sides to obtain a copper-free laminate (2-ply), which is formed by laminating two prepregs.

Test items and test methods are described below.

### Z-Axis Ratio of Thermal Expansion (Z-PTE)

The copper-free laminate (6-ply, obtained by laminating six prepregs) sample was subject to thermal mechanical analysis (TMA) during the ratio of thermal expansion (Z-axis) measurement. Each sample was heated from 50° C. to 260° C. at a heating rate of 10° C./minute and then subject to the measurement of Z-axis ratio of thermal expansion (in %) between 50° C. and 260° C. by reference to the method described in IPC-TM-650 2.4.24.5. Lower ratio of thermal expansion represents a better property of the sample. Generally, a difference in ratio of thermal expansion of greater than or equal to 0.1% represents a substantial difference.

Thermal Resistance after Moisture Absorption (Pressure Cooking Test, PCT)

The copper-free laminate (6-ply, obtained by laminating six prepregs) sample was subject to pressure cooking test by reference to IPC-TM-650 2.6.16.1 and 5 hours of moisture absorption (test temperature 121° C., relative humidity 100%), and then by reference to IPC-TM-650 2.4.23, the copper-free laminate sample after moisture absorption was immersed into a 288° C. solder bath for 20 seconds, and removed and inspected for the presence of delamination, wherein “OK” represents no occurrence of delamination (no occurrence of delamination represents pass), and “NG” represents occurrence of delamination (occurrence of delamination represents fail). For example, interlayer separation between insulation layers is considered as delamination. Interlayer delamination or blistering may occur between any layers of the laminate.

### Dissipation Factor (Df)

The aforesaid copper-free laminate (2-ply, obtained by laminating two prepregs) sample was subject to dissipation factor measurement. Each sample was measured by using a microwave dielectrometer (available from AET Corp.) by reference to JIS C2565 at room temperature (about 25° C.) and at 10 GHz frequency. Lower dissipation factor represents better dielectric properties of the sample. At 10 GHz frequency, for a Df value of less than 0.00180, a difference in Df value of less than 0.00003 represents no substantial difference in dissipation factor in different laminates, and a difference in Df value of greater than or equal to 0.00003 represents a substantial difference (i.e., significant technical difficulty) in dissipation factor in different laminates.

### Dissipation Factor Aging Variation Under Moisture and Heat (Df Aging Rate Under Moisture and Heat, Abbreviated Herein as Dfa (%))

A copper-free laminate sample (2-ply, obtained by laminating two prepregs) was tested by using a microwave dielectrometer available from AET Corp. by reference to JIS C2565 at 10 GHz at room temperature (about 25° C.), and the dissipation factor of each sample thus measured is designated as Df₁. Then the sample was washed with distilled water and placed in an environment of 85° C. and 85% relative humidity for 48 hours, followed by another measurement of the dissipation factor, which is designated as Df₂. The Df aging rate under moisture and heat, in %, is equal to ((Df₂−Df₁)/Df₁)*100%.

TABLE 1
Resin compositions of Examples (in part by weight) and test results

| Component | | E1 | E2 | E3 | E4 | E5 |
|---|---|---|---|---|---|---|
| polybutadiene | B-3000 | 100 | 100 | 100 | 100 | 100 |
| | B-1000 | | | | | |
| | B-2000 | | | | | |
| | Ricon130 | | | | | |
| block copolymer | self-made SBS1 | | | | 30 | |
| | NISSO-SBS | 15 | 30 | 55 | | |
| | self-made SBS2 | | | | | 30 |
| | D1118 | | | | | |
| | YH-792 | | | | | |
| | H1043 | | | | | |
| polyphenylene | SA9000 | | | | | |
| ether resin | | | | | | |
| crosslinking agent | TAIC | | | | | |
| inorganic filler | SC-2500 SVJ | 300 | 300 | 300 | 300 | 300 |
| curing accelerator | 25B | 1.75 | 1.75 | 1.75 | 1.75 | 1.75 |
| | BIBP | 1.5 | 1.5 | 1.5 | 1.5 | 1.5 |
| solvent | toluene | PA | PA | PA | PA | PA |

| Test item | Unit | E1 | E2 | E3 | E4 | E5 |
|---|---|---|---|---|---|---|
| Z-PTE | % | 0.93 | 0.99 | 1.05 | 1.07 | 0.88 |
| PCT thermal | / | OK | OK | OK | OK | OK |
| resistance | | | | | | |
| Df | / | 0.00160 | 0.00152 | 0.00148 | 0.00155 | 0.00146 |
| Dfa | % | 31% | 28% | 23% | 32% | 21% |

TABLE 2
Resin compositions of Examples (in part by weight) and test results

| Component | | E6 | E7 | E8 | E9 | E10 |
|---|---|---|---|---|---|---|
| polybutadiene | B-3000 | | | | | 45 |
| | B-1000 | 100 | 100 | 100 | | 25 |
| | B-2000 | | | | 100 | 30 |
| | Ricon130 | | | | | |
| block copolymer | self-made SBS1 | | | | | 14 |
| | NISSO-SBS | 15 | 30 | 55 | 15 | 8 |
| | self-made SBS2 | | | | 15 | 8 |
| | D1118 | | | | | |
| | YH-792 | | | | | |
| | H1043 | | | | | |
| polyphenylene | SA9000 | | | | | 5 |
| ether resin | | | | | | |
| crosslinking agent | TAIC | | | | | 5 |
| inorganic filler | SC-2500 SVJ | 300 | 300 | 300 | 300 | 280 |
| curing accelerator | 25B | 1.75 | 1.75 | 1.75 | 0.5 | 1.7 |
| | BIBP | 1.5 | 1.5 | 1.5 | 2 | 1.8 |
| solvent | toluene | PA | PA | PA | PA | PA |

| Test item | Unit | E6 | E7 | E8 | E9 | E10 |
|---|---|---|---|---|---|---|
| Z-PTE | % | 0.91 | 0.95 | 1.02 | 0.96 | 0.99 |
| PCT thermal | / | OK | OK | OK | OK | OK |
| resistance | | | | | | |
| Df | / | 0.00161 | 0.00152 | 0.00149 | 0.00151 | 0.00156 |
| Dfa | % | 35% | 30% | 26% | 24% | 29% |

TABLE 3
Resin compositions of Comparative Examples (in part by weight) and test results

| Component | | C1 | C2 | C3 | C4 | C5 |
|---|---|---|---|---|---|---|
| polybutadiene | B-3000 | 100 | 100 | | 100 | |
| | B-1000 | | | 100 | | |
| | B-2000 | | | | | |
| | Ricon130 | | | | | |
| block copolymer | self-made SBS1 | | | | | |
| | NISSO-SBS | | | | | 15 |
| | self-made SBS2 | | | | | |
| | D1118 | 30 | | | | |
| | YH-792 | | 30 | | | |
| | H1043 | | | 55 | | |
| polyphenylene | SA9000 | | | | | |
| ether resin | | | | | | |
| crosslinking agent | TAIC | | | | | |
| inorganic filler | SC-2500 SVJ | 300 | 300 | 300 | 300 | 300 |
| curing accelerator | 25B | 1.75 | 1.75 | 1.75 | 1.75 | 1.75 |
| | BIBP | 1.5 | 1.5 | 1.5 | 1.5 | 1.5 |
| solvent | toluene | PA | PA | PA | PA | PA |

| Test item | Unit | C1 | C2 | C3 | C4 | C5 |
|---|---|---|---|---|---|---|
| Z-PTE | % | 1.21 | 1.15 | 1.51 | 0.91 | X |
| PCT thermal | / | NG | NG | NG | NG | X |
| resistance | | | | | | |
| Df | / | 0.00175 | 0.00179 | 0.00169 | 0.00165 | X |
| Dfa | % | 42% | 45% | 30% | 35% | X |

TABLE 4
Resin compositions of Comparative Examples (in part by weight) and test results

| Component | | C6 | C7 | C8 | C9 |
|---|---|---|---|---|---|
| polybutadiene | B-3000 | | | | |
| | B-1000 | | | | |
| | B-2000 | | | | |
| | Ricon130 | | | 100 | 100 |
| block copolymer | self-made SBS1 | | | | |
| | NISSO-SBS | 55 | 115 | 15 | 55 |
| | self-made SBS2 | | | | |
| | D1118 | | | | |
| | YH-792 | | | | |
| | H1043 | | | | |
| polyphenylene | SA9000 | | | | |
| ether resin | | | | | |
| crosslinking agent | TAIC | | | | |
| inorganic filler | SC-2500 SVJ | 300 | 300 | 300 | 300 |
| curing accelerator | 25B | 1.75 | 1.75 | 1.75 | 1.75 |
| | BIBP | 1.5 | 1.5 | 1.5 | 1.5 |
| solvent | toluene | PA | PA | PA | PA |

| Test item | Unit | C6 | C7 | C8 | C9 |
|---|---|---|---|---|---|
| Z-PTE | % | X | 1.59 | 1.35 | 1.49 |
| PCT thermal | / | X | OK | NG | NG |
| resistance | | | | | |
| Df | / | X | 0.00159 | 0.00176 | 0.00166 |
| Dfa | % | X | 35% | 42% | 37% |

The following observations can be made from Table 1 to Table 4.

Examples E1-E10 (containing a styrene-butadiene-styrene triblock copolymer, wherein the content of 1,2-vinyl group of the butadiene block is greater than or equal to 80%), in contrast with Comparative Examples C1-C3 (not containing the styrene-butadiene-styrene triblock copolymer as defined according to the present disclosure), may achieve a Z-axis ratio of thermal expansion of less than or equal to 1.07%, no delamination in the test of thermal resistance after moisture absorption, and a dissipation factor of less than or equal to 0.00161. In contrast, Comparative Examples C1-C3 fail to achieve the above-mentioned effects.

Examples E1-E10 (containing a styrene-butadiene-styrene triblock copolymer, wherein the content of 1,2-vinyl group of the butadiene block is greater than or equal to 80%), in contrast with Comparative Example C4 (not containing any styrene-butadiene-styrene triblock copolymer), may achieve the effects of no delamination in the test of thermal resistance after moisture absorption and a dissipation factor of less than or equal to 0.00161. In contrast, Comparative Example C4 fails to achieve the above-mentioned effects.

Examples E1-E10 (containing a polybutadiene having a content of 1,2-vinyl group of greater than or equal to 85%), in contrast with Comparative Examples C5-C7 (not containing a polybutadiene), may achieve a Z-axis ratio of thermal expansion of less than or equal to 1.07%. In contrast, Comparative Examples C5-C7 fail to achieve the above-mentioned effect. Because Comparative Examples C5 and C6 were not able to be formed to make a sample (designated as “X”), property measurements thereof cannot be made.

Examples E1-E10 (containing a polybutadiene having a content of 1,2-vinyl group of greater than or equal to 85%), in contrast with Comparative Examples C8-C9 (containing a polybutadiene having a content of 1,2-vinyl group of less than 85%), may achieve a Z-axis ratio of thermal expansion of less than or equal to 1.07%, no delamination in the test of thermal resistance after moisture absorption, a dissipation factor of less than or equal to 0.00161 and a dissipation factor aging variation under moisture and heat of less than or equal to 35%. In contrast, Comparative Examples C8-C9 fail to achieve the above-mentioned effects.

The above detailed description is merely illustrative in nature and is not intended to limit the embodiments of the subject matter or the applications and uses of such embodiments. As used herein, the term “exemplary” or “example” means “serving as an example, instance, or illustration.” Any implementation described herein as exemplary is not necessarily to be construed as preferred or advantageous over other implementations, unless otherwise specified.

Moreover, while at least one exemplary example or comparative example has been presented in the foregoing detailed description, it should be appreciated that a vast number of variations exist. It should also be appreciated that the exemplary one or more embodiments described herein are not intended to limit the scope, applicability, or configuration of the claimed subject matter in any way. Rather, the foregoing detailed description will provide those skilled in the art with a convenient guide for implementing the described one or more embodiments and equivalents thereof. Also, the scope defined by the claims includes known equivalents and foreseeable equivalents at the time of filing this patent application.

What is claimed is:

1. A resin composition, comprising: (A) a polybutadiene having a content of 1,2-vinyl group of greater than or equal to 85%; and (B) a styrene-butadiene-styrene triblock copolymer of Formula (1) comprising a butadiene block having a content of 1,2-vinyl group of greater than or equal to 80%: 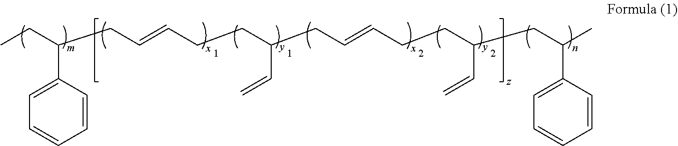
wherein x1, x2, y1 and y2 are each independently an integer of greater than or equal to 0, y1 and y2 are not 0 at the same time, and m, n and z are each independently an integer of greater than or equal to 1, and wherein:
m+n+(x1+x2)*z+(y1+y2)*z=A; m/A=0.1-0.4; n/A=0.1-0.4; [(x1+x2)*z]/A=0-0.1;
[(y1+y2)*z]/A=0.4-0.7.

2. The resin composition of claim 1, wherein a part by density of the styrene-butadiene-styrene triblock copolymer is greater than or equal to 39.

3. The resin composition of claim 1, wherein a part by density of the styrene-butadiene-styrene triblock copolymer is between 39 and 63.

4. The resin composition of claim 1, further comprising polyphenylene ether resin, maleimide resin, styrene maleic anhydride, epoxy resin, cyanate ester resin, maleimide triazine resin, phenolic resin, benzoxazine resin, polyester resin, amine curing agent or a combination thereof.

5. The resin composition of claim 1, further comprising flame retardant, curing accelerator, polymerization inhibitor, inorganic filler, surface treating agent, coloring agent, solvent or a combination thereof.

6. The resin composition of claim 1, further comprising a crosslinking agent, wherein the crosslinking agent comprises 1,2-bis(vinylphenyl)ethane, bis(vinylbenzyl)ether, divinylbenzene, divinylnaphthalene, divinylbiphenyl, t-butyl styrene, triallyl isocyanurate, triallyl cyanurate, 1,2,4-trivinyl cyclohexane, diallyl bisphenol A, styrene, decadiene, octadiene, vinylcarbazole, acrylate or a combination thereof.

7. The resin composition of claim 1, comprising: 100 parts by weight of (A) the polybutadiene and 15 to 55 parts by weight of (B) the styrene-butadiene-styrene triblock copolymer of Formula (1).

8. An article made from the resin composition of claim 1, wherein the article comprises a prepreg, a resin film, a laminate, or a printed circuit board.

9. The article of claim 8, having a Z-axis ratio of thermal expansion as measured by reference to IPC-TM-650 2.4.24.5 of less than or equal to 1.07%.

10. The article of claim 8, characterized in that no delamination occurs after subjecting the article to a pressure cooking test by reference to IPC-TM-650 2.6.16.1 followed by a thermal resistance test by reference to IPC-TM-650 2.4.23.

11. The article of claim 8, having a dissipation factor at 10 GHz as measured by reference to JIS C2565 of less than or equal to 0.00161.

12. The article of claim 8, having a dissipation factor aging variation under moisture and heat of less than or equal to 35% as calculated according to a dissipation factor at 10 GHz as measured by reference to JIS C2565 before and after the article is placed under a temperature of 85° C. and a relative humidity of 85% for 48 hours.
